(19) United States
(12) Patent Application Publication
(10) Pub. No.: US 2025/0125478 A1
(43) Pub. Date: Apr. 17, 2025

(54) SECONDARY BATTERY

(71) Applicant: Samsung SDI Co., Ltd., Yongin-si (KR)

(72) Inventor: Joong Woo NAM, Yongin-si (KR)

(21) Appl. No.: 18/642,542

(22) Filed: Apr. 22, 2024

(30) Foreign Application Priority Data
Oct. 17, 2023 (KR) 10-2023-0138457

(51) Int. Cl. H01M 50/317

(52) U.S. Cl. CPC H01M 50/317

(57) ABSTRACT

The present disclosure relates to a secondary battery which a vent portion can be reused. The secondary battery includes: an electrode assembly including a first electrode plate, a second electrode plate, and a separator; a case accommodating the electrode assembly and including at least one open side; a cap plate sealing the open side of the and including a vent hole; and a safety vent on the cap plate. The safety vent is configured to move between a closed position closing the vent hole and an open position opening the vent hole, and the safety vent has a magnetic force biasing the safety vent into the closed position.

### CROSS-REFERENCE TO RELATED APPLICATION

The present application claims priority to and the benefit of Korean Patent Application No. 10-2023-0138457, filed on Oct. 17, 2023, in the Korean Intellectual Property Office, the entire disclosure of which is incorporated herein by reference.

### BACKGROUND

### 1. Field

The present disclosure relates to a secondary battery.

### 2. Description of the Related Art

Unlike a primary battery that cannot be charged, a secondary battery is a battery that can be charged and discharged. Low-capacity batteries are used in portable small electronic devices such as mobile phones or camcorders, and large-capacity batteries in the form of a module in which dozens to hundreds of battery packs are connected are widely used as power sources for driving motors in hybrid vehicles, electric vehicles, etc.

A secondary battery may be constructed by inserting an electrode assembly and an electrolyte formed with a separator between a positive electrode plate and a negative electrode plate in a case, and installing a cap plate on the case. The electrode assembly may be a wound type or a stack type. This electrode assembly may have a non-coated tab protruding upwardly or laterally, and a current collection member may be connected to the non-coated tab.

The above information disclosed in this Background section is only for enhancement of understanding of the background of the disclosure and therefore it may contain information that does not constitute prior art.

### SUMMARY

The present disclosure relates to various embodiments of a secondary battery in which a vent portion can be reused.

These and other aspects and features of the present disclosure will be described in or will be apparent from the following description of embodiments of the present disclosure.

A secondary battery according to an embodiment of the present disclosure includes: an electrode assembly including a first electrode plate, a second electrode plate, and a separator; a case accommodating the electrode assembly and including at least open side; a cap plate sealing the open side of the case and including a vent hole; and a safety vent on the cap plate. The safety vent is configured to move between a closed position closing the vent hole and an open position opening the vent hole, and the safety vent has a magnetic force biasing the safety vent into the closed position.

The safety vent may include a border-shaped peripheral portion fixed to a portion of the cap plate facing the vent hole, a first member extending from one side of the peripheral portion toward a center of the vent hole, and a second member extending from the other side of the peripheral portion toward the center of the vent hole.

At least one of the first member and the second member may have the magnetic force.

The first member and the second member may have magnetic forces of different polarities.

The first member may have the magnetic force, and the second member may include at least one of iron, an iron alloy, nickel, or a cobalt alloy.

The first member may include a first body fixed to the peripheral portion and having elasticity, and a first wing extending from the first body in a direction toward the second member and having the magnetic force.

The second member may include a second body fixed to the peripheral portion and having elasticity, and a second wing extending from the second body in a direction toward the first member and having the magnetic force.

The first member may include a first protrusion and a first groove, and the second member may include a second groove detachably coupled to the first protrusion and a second protrusion detachably coupled to the first groove.

The cap plate and the safety vent may be integrally molded by a double injection molding process.

the secondary battery may further include an insulating member having a shape corresponding to the cap plate and located between the cap plate and the electrode assembly.

A secondary battery according to an embodiment of the present disclosure includes: an electrode assembly including a first electrode plate, a second electrode plate, and a separator; a case accommodating the electrode assembly and including a top opening; a cap plate sealing the top opening of the case and including a vent hole; and a safety vent on the cap plate. The safety vent is configured to move between a closed position closing the vent hole and an open position opening the vent hole, and the safety vent has a magnetic force biasing the safety vent into the closed position. The safety vent includes two or more layers.

The safety vent may include: a first vent portion on the cap plate; and a second vent portion at a lower side of the first vent portion, installed on the cap plate together with the first vent portion. The first vent portion and the second vent portion are both configured to move between a closed position closing the vent hole and an open position opening the vent hole and both include a magnetic force biasing the first vent portion and the second vent portion into the closed position.

The first vent portion may include: a border-shaped peripheral portion fixed to a portion of the cap plate facing the vent hole; a first member extending from one side of the peripheral portion toward a center of the vent hole; and a second member extending from an other side of the peripheral portion toward the center of the vent hole.

The first member and the second member may each include a magnetic material.

The magnetic material may include a plastic magnet.

The plastic magnet may include an organic ferromagnetic material (p-TCNQ).

A region where the first member and the second member are detachably coupled to each other may have any one of an “I” shape, an “S” shape, or a “W” shape in plan view.

### BRIEF DESCRIPTION OF DRAWINGS

The following drawings attached to this specification illustrate preferred embodiments of the present invention, and serve to further understand the technical idea of the present invention together with the detailed description of the invention described later, so the present invention should not be construed as limited to the matters described in such drawings.

FIG. 1 is a perspective view of a secondary battery according to an embodiment of the present disclosure.

FIG. 2 is a cross-sectional view of the secondary battery according to an embodiment of the present disclosure.

FIG. 3 is a perspective view showing a safety vent installed between a cap plate and an insulating member according to an embodiment of the present disclosure.

FIG. 4 is a perspective view showing a safety vent according to an embodiment of the present disclosure.

FIG. 5 is a plan view showing the safety vent according to an embodiment of the present disclosure.

FIG. 6 is a front cross-sectional view showing the safety vent according to an embodiment of the present disclosure.

FIG. 7 is a front cross-sectional view showing a state in which a safety vent according to an embodiment of the present disclosure is bent upward by gas pressure inside the secondary battery.

FIG. 8 is a perspective view showing a safety vent according to another embodiment of the present disclosure.

FIG. 9 is a plan view showing the safety vent according to another embodiment of the present disclosure.

FIG. 10 is a perspective view showing a safety vent according to another embodiment of the present disclosure.

FIG. 11 is a plan view showing the safety vent according to another embodiment of the present disclosure.

FIG. 12 is a front cross-sectional view showing a safety vent according to another embodiment of the present disclosure.

FIG. 13 is a plan view showing a safety vent according to another embodiment of the present disclosure.

FIG. 14 is a plan view showing a safety vent according to another embodiment of the present disclosure.

### DETAILED DESCRIPTION

Hereinafter, preferred embodiments of the present disclosure will be described in detail with reference to the accompanying drawings. Prior to describing the present disclosure, terms or words used in the present specification and claims are not to be limitedly interpreted as general or dictionary meanings and should be interpreted as meanings and concepts that are consistent with the technical idea of the present disclosure on the basis of the principle that an inventor may properly define concepts of terms to describe his or her invention in the best way. Therefore, the embodiments described in this specification and the configurations shown in the drawings are only some of the most preferred embodiments of the present disclosure and do not represent all of the technical spirit of the present disclosure, so it should be understood that there may be various equivalents and variations that can be substituted for these at the time of this application. In addition, as used herein, the terms that the terms “comprise or include” and/or “comprising or including,” when used in this specification, specify the presence of stated features, numbers, steps, operations, elements, and/or components, but do not preclude the presence or addition of one or more other features, numbers, steps, operations, elements, components, and/or groups thereof.

In addition, for a better understanding of the present disclosure, the accompanying drawings may not be drawn to scale, and dimensions of some components may be exaggerated. In addition, the same reference numbers may be assigned to the same components in different embodiments.

A reference to two comparable objects being “the same” means that they are “substantially the same”. Thus, the wording “substantially the same” may include a case of having a deviation that is considered low in the art, for example, a deviation of 5% or less. In addition, being uniform in a certain parameter in a predetermined region may mean that the parameter is uniform in terms of average.

It will be understood that, although the terms first, second, etc. may be used herein to describe various members, elements, regions, layers and/or sections, these members, elements, regions, layers and/or sections should not be limited by these terms.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked”, “coupled” or “connected” to another component, these components may be directly linked or connected to each other, but another component may be “interposed” between the components”, or the respective components may also be “linked”, “coupled” or “connected” through another component.

Throughout the specification, when referring to “A and/or B”, this means A, B or A and B, unless otherwise stated, and when referring to “C to D”, this means that it is more than C and less than D, unless otherwise stated.

The secondary battery 100 according to the embodiment of the present disclosure will be described with reference to the drawings.

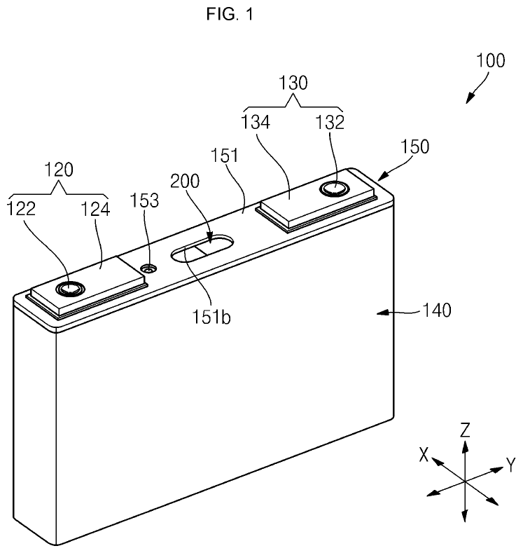

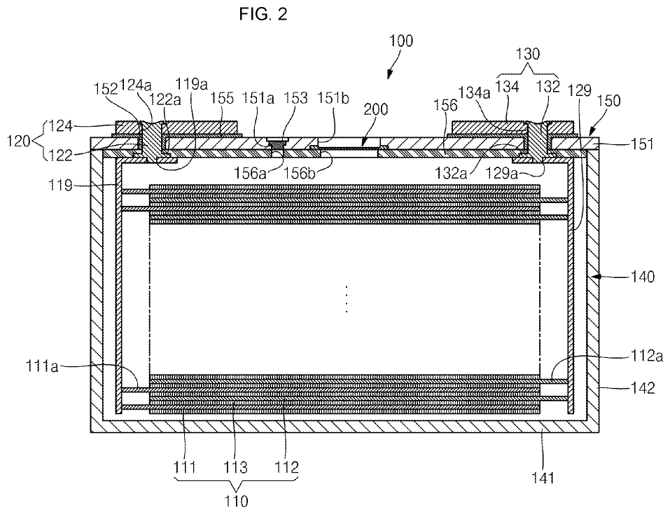

FIG. 1 is a perspective view of a secondary battery 100 according to an embodiment of the present disclosure and FIG. 2 is a cross-sectional view of the secondary battery 100 according to an embodiment of the present disclosure. As shown in FIGS. 1 and 2, the secondary battery 100 may include an electrode assembly 110, a first current collector 119, a first terminal 120, a second current collector 129, a second terminal 130, a case 140, a cap assembly 150, and a safety vent 200.

The electrode assembly 110 may be formed by winding or stacking a laminate of the first electrode plate 111, the separator 113, and the second electrode plate 112, which are formed in a thin plate or film shape. In an embodiment in which the electrode assembly 110 is a wound laminate, the winding axis may be parallel (or substantially parallel) to the longitudinal direction (y) of the case 140. In one or more embodiments, the electrode assembly 110 may be a stack type rather than a wound type, and the present disclosure is not limited to a particular shape of the electrode assembly 110. In one or more embodiments, the electrode assembly 110 may be a Z-stack electrode assembly 110 in which positive and negative electrode plates are inserted into both sides of the separator 113 and bent into a Z-stack. In addition, the electrode assembly 110 may be stored inside the case 140 by stacking one or more electrode assemblies 110 so that the long sides thereof are adjacent to each other, and the number of electrode assemblies 110 is not limited in the present disclosure. The first electrode plate 111 of the electrode assembly 110 may serve as a negative electrode and the second electrode plate 112 may serve as a positive electrode. In one or more embodiments, the first electrode plate 111 of the electrode assembly 110 may serve as a positive electrode and the second electrode plate 112 may serve as a negative electrode.

The first electrode plate 111 may be formed by applying a first electrode active material such as graphite or carbon to a first electrode current collector plate made of a metal foil such as copper, a copper alloy, nickel, or a nickel alloy, and may include a first electrode tab 111a (or a first uncoated portion), which is a region to which the first electrode active material is not applied. The first electrode tab 111a may be a passage for current flow between the first electrode plate 111 and the first current collector 119. In one or more embodiments, the first electrode tab 111a may be formed by cutting the metal foil to protrude on one side during manufacturing of the first electrode plate 111, and may protrude further to one side than the separator 113 without separately cutting. In one or more embodiments, a plurality of first electrode tabs 111a may be gathered together and tack-welded, and the first current collector 119 may be welded to the tack-welded first electrode tabs 111a, and thus may be coupled to each other.

The second electrode plate 112 may be formed by applying a second electrode active material such as a transition metal oxide to a second electrode current collector plate formed of a metal foil such as aluminum or an aluminum alloy, and may include a second electrode tab 112a (or a second uncoated portion), which is a region to which the second electrode active material is not applied. The second electrode tab 112a may be a passage for current flow between the second electrode plate 112 and the second current collector 129. In one or more embodiments, the second electrode tab 112a may be formed by cutting the metal foil to protrude on the other side during manufacturing of the second electrode plate 112, and may protrude further to the other side than the separator 113 without separately cutting. In one or more embodiments, a plurality of second electrode tabs 112a may be gathered together and tack-welded, and the second current collector 129 may be welded to the tack-welded second electrode tabs 112a, and thus may be coupled to each other.

In one or more embodiments, the first electrode tab 111a may be located on the left side of the electrode assembly 110, and the second electrode tab 112a may be located on the right side of the electrode assembly 110, or the first electrode tab 111a and the second electrode tab 112a may be located on one side in the same direction (e.g., the Y-direction). As used herein, the left and right sides are presented for convenience of explanation based on the secondary battery 100 shown in FIG. 1, and the position may change when the secondary battery 100 is rotated left and right or up and down.

The first electrode tab 111a of the first electrode plate 111 and the second electrode tab 112a of the second electrode plate 112 are located at opposite ends of the electrode assembly 110. In one or more embodiments, the electrode assembly 110 may be accommodated in the case 140 along with an electrolyte. In addition, in the electrode assembly 110, the first current collector 119 and the second current collector 129 welded and connected to the first electrode tab 111a of the first electrode plate 111 and the second electrode tab 112a of the second electrode plate 112, respectively.

In one or more embodiments, the separator 113 may be located between the first electrode plate 111 and the second electrode plate 112 and may serve to prevent short circuit and enable the movement of lithium ions. The separator 113 may include polyethylene, polypropylene, or a composite film of polyethylene and polypropylene. In one or more embodiments, the separator 113 may be replaced with an inorganic solid electrolyte such as a sulfide-based, oxide-based, or phosphate-based electrolyte that does not require a liquid or gel electrolyte.

The first current collector 119 and the second current collector 129, which are electrically connected to the first electrode tab 111a of the first electrode plate 111 and the second electrode tab 112a of the second electrode plate 112, respectively, are located at opposite ends of the electrode assembly 110. In one or more embodiments, the electrode assembly 110 may be accommodated in the case 140 together with an electrolyte.

In one or more embodiments, the electrolyte may include a lithium salt such as LiPF6 or LiBF4 in an organic solvent such as EC, PC, DEC, EMC, or DMC. In addition, the electrolyte may be in a liquid or gel phase. In one or more embodiments, when an inorganic solid electrolyte is used, the electrolyte may be omitted.

In one or more embodiments, the first current collector 119 may be in contact with the first electrode tab 111a protruding to one end of the electrode assembly 110. In one or more embodiments, the first current collector 119 may be welded to the first electrode tab 111a. In one or more embodiments, the first current collector 119 is formed in an approximately “L” shape, and a terminal hole 119a may be formed at an upper portion thereof. In one or more embodiments, a first terminal pillar 122 may be inserted into the terminal hole 119a and riveted and/or welded. In one or more embodiments, the first current collector 119 may be made of copper or a copper alloy.

The first terminal 120 is made of metal and may be electrically connected to the first electrode plate 111 through the first current collector 119. In one or more embodiments, the first terminal 120 may include the first terminal pillar 122 and a first terminal plate 124.

In one or more embodiments, the first terminal pillar 122 may protrude and extend a certain length upward through the cap plate 151 of the cap assembly 150, and may be electrically connected to the first current collector 119 at a lower portion of the cap plate 151. In addition, in one or more embodiments, the first terminal pillar 122 may protrude and extend a certain length to an upper portion of the cap plate 151, and a flange 122a may be formed at the lower portion of the cap plate 151 to prevent the first terminal pillar 122 from falling out of the cap plate 151. The region of the first terminal pillar 122 located below the flange 122a may be inserted into the first terminal hole 119a of the first current collector 119 and then riveted and/or welded. In one or more embodiments, the first terminal pillar 122 may be made of copper, a copper alloy, aluminum, or an aluminum alloy.

The first terminal plate 124 has a hole 124a, and the first terminal pillar 122 may be coupled to the hole 124a and riveted and/or welded. In one or more embodiments, facing surfaces between the upwardly exposed first terminal pillar 122 and the first terminal plate 124 may be welded to each other. In one or more embodiments, by providing a laser beam to boundary portions of the upwardly exposed first terminal pillar 122 and the first terminal plate 124, the boundary portions may be welded by being melted together and then cooled. In one or more embodiments, the first terminal pillar 122 and the first terminal plate 124 may be electrically insulated from the cap plate 151.

The second current collector 129 may be in contact with the second electrode tab 112a protruding to one end of the electrode assembly 110. In one or more embodiments, the second current collector 129 is formed in an approximately “L” shape, and a terminal hole 129a may be formed at an upper portion thereof. In one or more embodiments, the second terminal pillar 132 is inserted and coupled to the terminal hole 129a. The second current collector 129 may be made of, for example, but not limited to, aluminum or an aluminum alloy. The second terminal pillar 132 may protrude and extend upward for a certain length through the cap plate 151, which will be described later, and may be electrically connected to the second current collector 129 at the lower portion of the cap plate 151.

The second terminal 130 is also made of metal and may be electrically connected to the second electrode plate 112 through the second current collector 129. In one or more embodiments, the second terminal 130 may include a second terminal pillar 132 and a second terminal plate 134.

The second terminal pillar 132 may protrude and extend a certain length upward from the cap plate 151, and a flange 132a may be formed at a lower portion of the cap plate 151 to prevent the second terminal pillar 132 from falling out of the cap plate 151. The region of the second terminal pillar 132 located below the flange 132a may be inserted into the terminal hole 129a of the second current collector 129 and then riveted and/or welded.

In one or more embodiments, the second terminal pillar 132 may be made of aluminum or an aluminum alloy. The second terminal plate 134 has a hole 134a. In addition, the second terminal plate 134 is coupled to the second terminal pillar 132. That is, the second terminal pillar 132 is coupled to the hole 134a of the second terminal plate 134. In addition, the second terminal pillar 132 and the second terminal plate 134 may be riveted and/or welded to each other. In one or more embodiments, boundary portions of the upwardly exposed second terminal pillar 132 and the second terminal plate 134 may be welded to each other. In one or more embodiments, by providing a laser beam to the boundary portions of the upwardly exposed second terminal pillar 132 and the second terminal plate 134, the boundary portions may be welded by being melted together and then cooled.

In one or more embodiments, the second terminal pillar 132 and the second terminal plate 134 may be electrically insulated from the cap plate 151. In one or more embodiments, the second terminal pillar 132 and the second terminal plate 134 may be electrically connected to the cap plate 151. In one or more embodiments, the cap plate 151 of the cap assembly 150 may have the same polarity (e.g., a positive polarity) as the second terminal 130.

The case 140 may be shaped of a hollow rectangular parallelepiped having an opening at an upper portion thereof. The electrode assembly 110 may be inserted into the case 140 through the opening. In addition, the first current collector 119 of the first terminal 120 and the second current collector 129 of the second terminal 130 may also be located inside the case 140. The case 140 may include a rectangular bottom surface 141 and four lateral surfaces 142 extending in an approximately vertical direction from the four sides of the bottom surface 141.

The cap assembly 150 may be coupled to case 140. In one or more embodiments, the cap assembly 150 may include a cap plate 151, a seal gasket 152, a plug 153, an upper coupling member 155, and an insulating member 156.

The cap plate 151 seals the opening of the case 140, which is open on at least one side, and may be formed of the same material as the case 140. The case 140 can be modified in various ways, such as having both ends open or only one side open. Accordingly, the cap plate 151 may be implemented in in various embodiments in which the open portion of the case 140 is sealed.

In one or more embodiments, the cap plate 151 may be coupled to the case 140 by, but not limited to, laser welding. In one or more embodiments, since the cap plate 151 may have the same polarity as the second terminal 130 as described above, the cap plate 151 and the case 140 may have the same polarity. In the illustrated embodiment, the cap plate 151 further includes an electrolyte injection hole 151a and a vent hole 151b penetrating between the upper and lower surfaces.

The seal gasket 152 is made of an insulating material and is formed between the cap plate 151 and the first terminal pillar 122 of the first terminal 120 and between the cap plate 151 and the second terminal pillar 132 of the second terminal 130, respectively. The seal gasket 152 seals a portion between each of the first terminal pillar 122 and the second terminal pillar 132 and the cap plate 151. The seal gasket 152 prevents (or at least mitigates) external moisture from penetrating into the secondary battery 100 and/or prevents (or at least mitigates) the electrolyte contained within the secondary battery 100 from leaking out.

The plug 153 may seal the electrolyte injection hole 151a after the electrolyte is injected into the case 140 through the electrolyte injection hole 151a of the cap plate 151.

The upper coupling member 155 may be formed between each of the first terminal pillar 122 and the second terminal pillar 132 and the cap plate 151 at the upper portion of the cap plate 151. In addition, the upper coupling member 155 is in close contact with the cap plate 151. Moreover, the upper coupling member 155 may also be in close contact with the seal gasket 152. The upper coupling member 155 may insulate the first terminal pillar 122, the second terminal pillar 132, and the cap plate 151 from each other. In one or more embodiments, the upper coupling member 155 is interposed (located) between the second terminal plate 134 and the cap plate 151 and may electrically connect the second terminal plate 134 and the cap plate 151, and accordingly, the cap plate 151 may have the same polarity as the second terminal 130.

The insulating member 156 may be shaped to correspond to the cap plate 151 and may be modified into various shapes in which the insulating member 156 is located between the cap plate 151 and the electrode assembly 110. The insulating member 156 is sized to approximately correspond to the lower surface of the cap plate 151 and may be in close contact with the lower surface of the cap plate 151. In one or more embodiments, an electrolyte injection hole 156a and a vent hole 156b may be formed in the insulating member 156 at positions corresponding to those of the electrolyte injection hole 151a and the vent hole 151b formed in the cap plate 151. The insulating member 156 may prevent undesirable short circuits from occurring between the first current collector 119 and the cap plate 151 and between the second current collector 129 and the cap plate 151. In addition, the insulating member 156 is formed to have a size corresponding to that of the cap plate 151, thereby preventing undesirable short circuits between the electrode assembly 110 and the cap plate 151. In one or more embodiments, the insulating member 156 may be made of polyphenylene sulfide (PPS), which has a high melting point (285° C.) and high tensile strength, and accordingly, when heat from an internal short circuit caused by penetration of the secondary battery 100 is discharged through the safety vent 200, heat propagation to adjacent cells can be prevented, thereby improving safety. The insulating member 156 can prevent the heat caused by an internal short circuit of the secondary battery 100 from being transferred to an adjacent secondary battery 100 through the cap assembly 150. In an embodiment in which the secondary battery 100 includes one unit cell, it may not be necessary to block heat propagation to the adjacent secondary battery 100, and thus polypropylene (PP) may also be applied to the insulating member 156.

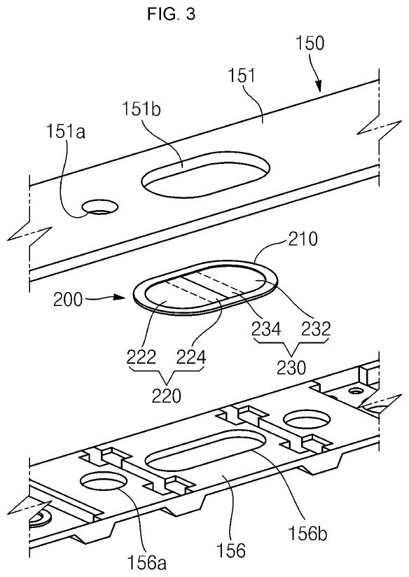

FIG. 3 is a perspective view showing a safety vent 200 installed between a cap plate 151 and an insulating member 156 according to an embodiment of the present disclosure. As shown in FIG. 3, the safety vent 200 is installed at a position facing the vent hole 151b of the cap plate 151, and the safety vent 200 may be configured to be opened at a set pressure. The safety vent 200 is installed on the cap plate 151 to close or open the vent hole 151b, and may be modified into various shapes. The safety vent 200 employs a plurality of magnetic materials, and when the pressure inside the secondary battery 100 is greater than the outside, the vent hole 151b is opened to release the gas, and then the vent hole 151b is sealed again by magnetic force. The safety vent 200 has elasticity and can be manufactured using a plurality of materials having a magnetic force. By using the safety vent 200 having a magnetic force that closes the safety vent 200, the secondary battery 100 can be reused by sealing the vent hole 151b using magnetic force after the gas is released. In addition, an electrolyte may be injected into the secondary battery 100 through the safety vent 200. When the electrolyte is supplied to the inside of the secondary battery 100 through the safety vent 200, the electrolyte injection hole 151a provided in the cap plate 151 and the electrolyte injection hole 156a provided in the insulating member 156 may not be included.

The safety vent 200 may be installed (located) on the lower side of the cap plate 151. The safety vent 200 is installed (located) between the cap plate 151 and the insulating member 156, and the safety vent 200 may open and close the vent hole 151b provided in the cap plate 151 and the vent hole 156b provided in the insulating member 156.

In one or more embodiments, the cap plate 151 and the safety vent 200 may be integrally molded by a double injection molding process. The double injection molding process is a molding process used to combine two or more different materials into one part. The double injection molding process can improve product properties by simultaneously forming two or more different materials in one operation. The double injection molding process is accomplished by using two different injection molding machines or by adding two injection units to one injection machine. In one or more embodiments, the cap plate 151 and the safety vent 200 are simultaneously (or substantially simultaneously) molded and combined through a double injection molding process, and thus can be used as components of the secondary battery 100. Since the cap plate 151 and the safety vent 200 are molded as one piece, the product manufacturing process can be performed efficiently and high accuracy and bonding strength between parts can be achieved.

In addition, in one or more embodiments, the safety vent 200 and the insulating member 156 may be integrally molded by a double injection molding process.

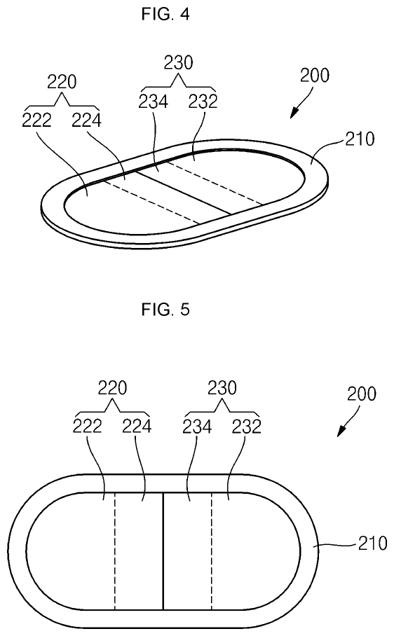

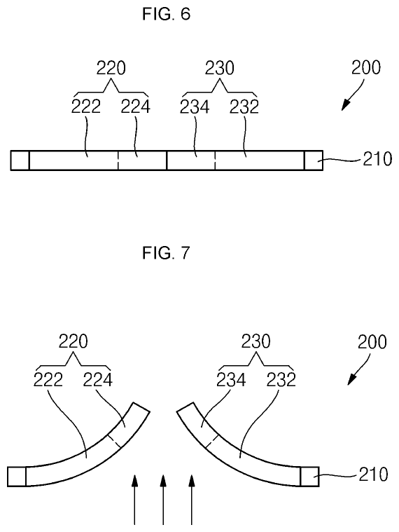

FIG. 4 is a perspective view showing a safety vent 200 according to an embodiment of the present disclosure, FIG. 5 is a plan view showing the safety vent 200 according to an embodiment of the present disclosure, and FIG. 6 is a front cross-sectional view showing the safety vent 200 according to an embodiment of the present disclosure.

As shown in FIGS. 4 to 7, the safety vent 200 is modified in shape by an external force to form a passage through which gas moves, and when the external force is removed, returns to its initial state by magnetic force and blocks the open passage. The safety vent 200 according to an embodiment of the present disclosure may include a peripheral portion 210, a first member 220, and a second member 230.

The peripheral portion 210 can be modified into various shapes in which the peripheral portion 210 is shaped of a border (or boundary) fixed to the cap plate 151 facing the vent hole 151b. The peripheral portion 210 may be integrally fixed to the cap plate 151, and may be inserted into and fixed to a groove provided in the cap plate 151. In addition, the peripheral portion 210 can be molded from a material having elasticity. The peripheral portion 210 may be installed in the shape of a strip surrounding the outside (e.g., the periphery) of the first member 220 and the second member 230. The peripheral portion 210 according to an embodiment of the present disclosure may have an approximately oval shape. Both ends of the peripheral portion 210 may form curved surfaces, and the body of the peripheral portion 210 may extend in a straight (or substantially straight) direction. In the safety vent 200, the structure of the peripheral portion 210 may be omitted, and the first member 220 and the second member 230 may be directly connected to the cap assembly 150 or the insulating member 156.

The first member 220 may be modified into various shapes in which the first member 220 extends from one side of the peripheral portion 210 (the left side in FIG. 5) toward the center of the vent hole 151b. The second member 230 may be modified into various shapes in which the second member 230 extends from the other side of the peripheral portion 210 (the right side in FIG. 5) toward the center of the vent hole 151b.

At least one of the first member 220 and the second member 230 may have a magnetic force configured to close the first member 220 and/or the second member 230. Due to the magnetic force, the first member 220 and the second member 230 may be restored to an initial state in which the vent hole 151b is blocked. In one or more embodiments, the first member 220 has a magnetic force, and the second member 230 may include at least one of iron, an iron alloy, nickel, and a cobalt alloy. In one or more embodiments, only the first member 220 may have magnetic force, and the second member 230 may include a material that is attracted (e.g., pulled) to the magnetic force. In one or more embodiments, only the second member 230 may have magnetic force, and the first member 220 may include a material that is attracted (e.g., pulled) to the magnetic force.

The first member 220 and the second member 230 may be in contact with each other at the center of the peripheral portion 210 in a state of facing each other. The region where the first member 220 and the second member 230 are coupled to each other may be formed in an “I” shape (e.g., a straight line shape) in plan view.

In one or more embodiments, both the first member 220 and the second member 230 may have magnetic force. In one or more embodiments, the first member 220 and the second member 230 may have magnetic forces of different polarities, and thus, when external force is removed, the first member 220 and the second member 230 may move in a direction of being in contact with each other.

The first member 220 is fixed to the peripheral portion 210 and may be modified into various shapes having elasticity. The first member 220 is located inside the peripheral portion 210 and may be shaped of a plate that is bendable. In addition, the first member 220 may have magnetism at a position facing the second member 230. The first member 220 may be connected to one side of the peripheral portion 210, and the second member 230 may be connected to the other side of the peripheral portion 210. The first member 220 according to one or more embodiments of the present disclosure may include a first body 222 and a first wing 224.

The first body 222 may be shaped of a plate having elasticity, one side of the first body 222 may be connected to the peripheral portion 210, and the other side of the first body 222 may be connected to the first wing 224. When the first member 220 is deformed by an external force, relatively more deformation may occur in the first body 222 than in the first wing 224.

The first wing 224 extends from the first body 222 toward the second member 230, and may be modified into various shapes having magnetic force. The first wing 224 and the first body 222 may be integrally formed, and the first wing 224 may be formed in the shape of a plate. The first wing 224 may be a magnetic material having elasticity.

The first wing 224 may include a magnetic material. In one or more embodiments, the magnetic material may include a plastic magnet. In addition, the plastic magnet may include an organic ferromagnetic material (p-TCNQ).

The organic ferromagnetic material (p-TCNQ) is an organic material that exhibits strong magnetism by including a compound called tetracyanoquinodimethane (TCNQ). By including TCNQ, the organic ferromagnetic material (p-TCNQ) may be obtained through a process of preparing a mixture by mixing an organic ferromagnetic precursor, such as tetracyanoethylene (TCNE) or tetracyanoanthraquinodimethane (TCAQ), with an acidic solvent.

In the above process, materials such as trifluoroacetic acid (TFA) and methyl sulfate (MSA) are used as the acidic solvent, and these acidic solvents are produced by being mixed with an organic ferromagnetic precursor. The weight ratio of the acidic solvent and the organic ferromagnetic precursor may be mixed at about 1:3 to 10, such as at a ratio of 1:5 to 7.

Thereafter, the organic ferromagnetic material (p-TCNQ) is formed through a heat treatment process. The heat treatment includes steps performed at 45-60° C., 95-120° C., and 135-145° C., each for 30 minutes to 2 hours. In one or more embodiments, desired characteristics of the ferromagnetic material can be obtained by controlling the heat treatment temperature and time. Subsequently, a self-polymerization reaction is performed to produce the compound.

In addition, in one or more embodiments, the purified self-polymerization reaction product is subjected to freeze-drying and annealing. In one or more embodiments, the freeze drying is performed at a pressure of 0.01-0.1 mmHg and a temperature of −160° C. to −80° C., and the annealing is performed at 330° C. to 410° C. or lower.

The organic ferromagnetic material (p-TCNQ) may contain less than 0.030 ppm of metal, and may be composed of a self-polymerized organic ferromagnetic material including 50-70 wt % of C, 1-5 wt % of H, 5-15 wt % of N, and 20-30 wt % of O. These characteristics of the organic ferromagnetic material may be adjusted in various ways according to the self-polymerization reaction temperature, composition, and processing process.

As described above, the organic ferromagnetic material (p-TCNQ) is an organic material produced by mixing a ferromagnetic precursor such as TCNQ with an acidic solvent and formed through heat treatment and processing.

The first wing 224 may be formed of a material having magnetism and elasticity in addition to the organic ferromagnetic material. In one or more embodiments, the first wing 224 may include at least one of a ferrite magnetic material, magnetic rubber, or polymer. The ferrite magnetic material has a special magnetic property as a magnetic material, and at the same time may exhibit elasticity to a certain degree of deformation. In one or more embodiments, the magnetism can be imparted by mixing magnetic particles with a specific type of polymer or rubber. Such magnetic rubber and polymer may have a magnetic function as well as elasticity.

The second member 230 is fixed to the peripheral portion 210 and may be modified into various shapes having elasticity. The second member 230 is located inside the peripheral portion 210 and may be shaped of a plate enabling a bending operation. In addition, the second member 230 may have magnetism at a position facing the first member 220. The second member 230 according to one or more embodiments of the present disclosure may include a second body 232 and a second wing 234.

The second body 232 may be shaped of a plate having elasticity, one side of the second body 232 may be connected to the peripheral portion 210, and the other side of the second body 232 may be connected to the second wing 234. When the second member 230 is deformed by an external force, relatively more deformation may occur in the second body 232 than in the second wing 234.

The second wing 234 extends from the second body 232 toward the first member 220, and may be modified into various shapes having magnetic force. The second wing 234 and the second body 232 may be integrally formed, and the second wing 234 may be formed in the shape of a plate. The second wing 234 may be a magnetic material having elasticity.

The second wing 234 may include a magnetic material. In one or more embodiments, the magnetic material may include a plastic magnet. In addition, the plastic magnet may include an organic ferromagnetic material (p-TCNQ).

The second wing 234 may be formed of a material having magnetism and elasticity in addition to the organic ferromagnetic material. In one or more embodiments, the second wing 234 may include at least one of a ferrite magnetic material, magnetic rubber, or polymer.

The magnetic material contained in first member 220 and second member 230 may not lose magnetic force until approximately 350° C. Therefore, the safety vent 200 can operate stably even in a high temperature environment.

In addition, in one or more embodiments, the pressure at which coupling between the first member 220 and the second member 230 is released is in a range from approximately 8 kgf/cm² to approximately 12 kgf/cm². When the pressure at which coupling between the first member 220 and the second member 230 is released is less than approximately 8 kgf/cm², the coupling between the first member 220 and the second member 230 is released even by a small gas pressure, and thus the operational reliability of the secondary battery 100 may be lowered. In addition, when the pressure at which coupling between the first member 220 and the second member 230 is released is greater than approximately 12 kgf/cm², the gas pressure inside the secondary battery 100 may increase too high, and thus the operational reliability of the secondary battery 100 may deteriorate.

The thicknesses of the first member 220 and the second member 230 may be in a range from approximately 1 mm to approximately 10 mm. When the thicknesses of the first member 220 and the second member 230 are less than approximately 1 mm, the structural rigidity of each of the first member 220 and the second member 230 may be weakened, thereby lowering durability. When the thicknesses of the first member 220 and the second member 230 exceed approximately 10 mm, gas cannot be discharged smoothly due to the lack of elasticity of the first member 220 and the second member 230.

FIG. 7 is a front cross-sectional view showing a state in which a safety vent 200 according to an embodiment of the present disclosure is bent upward by gas pressure. As shown in FIG. 7, the safety vent 200 is bent upward by a gas pressure higher than a set (or predetermined) pressure and discharges gas.

In one or more embodiments, the first wing 224 and the second wing 234 are spaced apart from each other by a gas pressure higher than the set (or predetermined) pressure and thus moving the safety vent from a state in which the first wing 224 and the second wing 234 are in contact with each other by magnetic force. In addition, the first member 220 and the second member 230 are bent upward, forming a passage for gas movement between the first wing 224 and the second wing 234.

When the gas pressure falls below the set (or predetermined) pressure, the first wing 224 and the second wing 234 come into contact with each other due to the magnetic forces of the first wing 224 and the second wing 234, thereby preventing gas from being discharged.

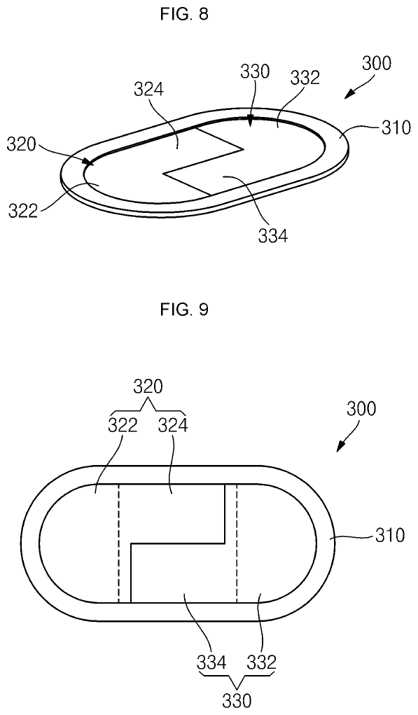

FIG. 8 is a perspective view showing a safety vent 300 according to another embodiment of the present disclosure and FIG. 9 is a plan view showing the safety vent 300 according to the embodiment illustrated in FIG. 8. As shown in FIGS. 8 and 9, the safety vent 300 according to another embodiment of the present disclosure includes a peripheral portion 310, a first member 320, and a second member 330. The first member 320 may include a first body 322 and a first wing 324, and the second member 330 may include a second body 332 and a second wing 334. In one or more embodiments, the peripheral portion 310, the first body 322, and the second body 332 of the embodiment illustrated in FIGS. 8-9 are the same or similar to the corresponding elements of the previous embodiment of the present disclosure, and therefore detailed descriptions thereof will be omitted.

The first wing 324 may be a plate-shaped magnetic material in an “L” shape, and the second wing 334 may be a plate-shaped magnetic material in an “L” shape. Since the protrusion of the first wing 324 and the protrusion of the second wing 334 are positioned misaligned with each other, the area where the first wing 324 and the second wing 334 are connected by magnetic force may increase, and thus the first wing 324 and the second wing 334 can be molded even with a relatively small amount of magnetic material.

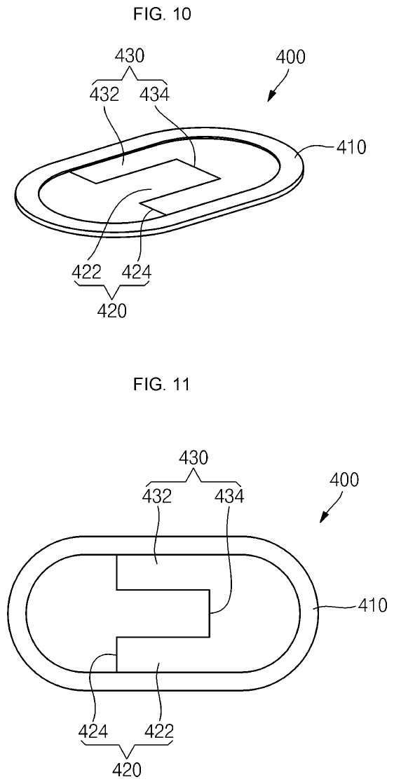

FIG. 10 is a perspective view showing a safety vent 400 according to another embodiment of the present disclosure and FIG. 11 is a plan view showing the safety vent 400 according to the embodiment illustrated in FIG. 10. As shown in FIGS. 10 and 11, the safety vent 400 according to another embodiment of the present disclosure may include a peripheral portion 410, a first member 420, and a second member 430. The first member 420 may include a first projection 422 and a first groove 424, and the second member 430 may include a second projection 432 and a second groove 434. In one or more embodiments, the peripheral portion 410 according to the embodiment illustrated in FIGS. 10-11 is the same or similar to the corresponding element of the previous embodiment of the present disclosure, and therefore a detailed description thereof will be omitted.

The first member 420 may include a first protrusion 422 and a first groove 424, and the second member 430 may include a second groove 434 detachably coupled to the first protrusion 422 and a second protrusion 432 detachably coupled to the first groove 424. The first member 420 is plate-shaped, and one side of the first member 420 is connected to the peripheral portion 410. In the first member 420, the first protrusion 422 protruding in the direction toward the second member 430 is inserted into the second groove 434, which is a groove provided in the second member 430. The second protrusion 432 is provided on both sides of the second groove 434 in the width direction. The second protrusion 432 protrudes in a direction toward the first member 420 and is inserted into the first groove 424 located on both sides of the first protrusion 422 in the width direction. Accordingly, in the illustrated embodiment, the first member 420 and the second member 430 are interlaced.

Both the first member 420 and the second member 430 are molded from a magnetic material with elasticity, and since the contact area between the first member 420 and the second member 430 increases compared to the embodiments depicted in FIGS. 1-7 and 8-9, the first member 420 and the second member 430 can be molded even with a relatively small amount of magnetic material.

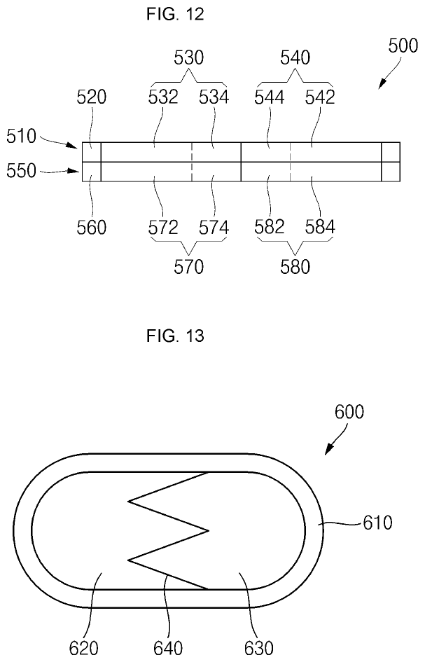

FIG. 12 is a front cross-sectional view showing a safety vent 500 according to another embodiment of the present disclosure. As shown in FIG. 12, the safety vent 500 may include multiple layers. In addition, vent portions forming the respective layers may have openings of different shapes, but in one or more embodiments may be the same.

The safety vent 500 according to this embodiment of the present disclosure may be in a state in which two layers are stacked. The safety vent 500 may include a first vent portion 510 that is installed on a cap plate 151 and closes or opens a vent hole 151b by magnetic force, and a second vent portion 550 that is located below the first vent portion 510 and installed on the cap plate 151 together with the first vent portion 510 and closes or opens the vent hole 151b by magnetic force.

The first vent portion 510 may include a border-shaped peripheral portion 520 that is fixed to the cap plate 151 facing the vent hole 151b, a first member 530 that extends from one side of the peripheral portion 520 toward the center of the vent hole 151b, and a second member 540 that extends from the other side of the peripheral portion 520 toward the center of the vent hole 151b. The first member 530 may include a first body 532 and a first wing 534, and the second member 540 may include a second body 542 and a second wing 544.

The second vent portion 550 may include a border-shaped peripheral portion 560 that is fixed to the cap plate 151 facing the vent hole 151b, a first member 570 that extends from one side of the peripheral portion 560 toward the center of the vent hole 151b, and a second member 580 that extends from the other side of the peripheral portion 560 toward the center of the vent hole 151b. The first member 570 may include a first body 572 and a first wing 574, and the second member 580 may include a second body 584 and a second wing 582.

The first vent portion 510 and the second vent portion 550 may have the shapes which are the same as or similar to each other. The safety vent 500 is the same or similar to the safety vent 200 presented in one embodiment of the present invention, so detailed explanations are omitted in comparison. The first member 570 and the second member 580 may include magnetic material, and the second vent portion 550 may be installed below the first vent portion 510. The first vent portion 510 and the second vent portion 550, while moving in unison, may release gas in excess of a predetermined threshold. In one or more embodiments, the safety vent 500 may function as a passage supplying electrolyte to the inside of the secondary battery 100.

FIG. 13 is a plan view showing a safety vent 600 according to another embodiment of the present disclosure. As shown in FIG. 13, the safety vent 600 according to another embodiment of the present disclosure may include a peripheral portion 610, a first member 620, and a second member 630. In one or more embodiments, the peripheral portion 610 has the same configuration as the corresponding element of the previous embodiment of the present disclosure, and therefore a detailed description thereof will be omitted.

In one or more embodiments, the first member 620 and the second member 630 are molded with a magnetic material having elasticity, and a boundary line 640 where the first member 620 and the second member 630 face each other in a “W” shape (e.g., a zigzag shape) in a plan view. Since the region where the first member 620 and the second member 630 are coupled to each other is in the “W” shape in plan view, the area where the first member 620 and the second member 630 are in contact with each other may increase, and thus the first member 620 and the second member 630 can be molded with a relatively small amount of magnetic material.

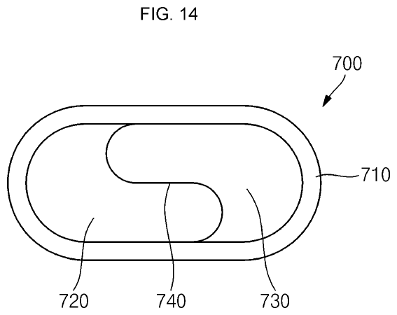

FIG. 14 is a plan view showing a safety vent 700 according to another embodiment of the present disclosure. As shown in FIG. 14, the safety vent 700 according to another embodiment of the present disclosure may include a peripheral portion 710, a first member 720, and a second member 730. In one or more embodiments, the peripheral portion 710 has the same configuration as that of the previous embodiment of the present disclosure, and therefore a detailed description thereof will be omitted.

In one or more embodiments, the first member 720 and the second member 730 are molded from a magnetic material having elasticity, and a boundary line 740 where the first member 720 and the second member 730 face each other is in an “S” shape (e.g., a serpentine or sinewave shape). Since the region where the first member 720 and the second member 730 are coupled to each other is in the “S” shape in plan view, the area where the first member 720 and the second member 730 are in contact with each other may increase, and thus the first member 720 and the second member 730 can be molded with a relatively small amount of magnetic material.

As described above, according to the present disclosure, since an elastic, magnetic safety vent is used, the safety vent can be reused and maintenance costs can be reduced.

However, the effects that can be obtained through the present disclosure are not limited to the above-mentioned effects, and other technical effects not mentioned can be clearly understood by a person skilled in the art from the description of the invention described below.

While the foregoing embodiment has been described to practice the present disclosure, it should be understood that the embodiment described herein should be considered in a descriptive sense only and not for purposes of limitation, and various changes in form and details may be made therein without departing from the spirit and scope of the disclosure as defined by the following claims.

What is claimed is:

1. A secondary battery comprising:
an electrode assembly comprising a first electrode plate, a second electrode plate, and a separator;
a case accommodating the electrode assembly, the case comprising at least one open side;
a cap plate sealing the at least one open side of the case, the cap plate comprising a vent hole; and
a safety vent on the cap plate, wherein the safety vent is configured to move between a closed position closing the vent hole and an open position opening the vent hole, and wherein the safety vent has a magnetic force biasing the safety vent into the closed position.

2. The secondary battery as claimed in claim 1, wherein the safety vent comprises:
a border-shaped peripheral portion fixed to a portion of the cap plate facing the vent hole;
a first member extending from one side of the peripheral portion toward a center of the vent hole; and
a second member extending from an other side of the peripheral portion toward the center of the vent hole.

3. The secondary battery as claimed in claim 2, wherein at least one of the first member and the second member has the magnetic force.

4. The secondary battery as claimed in claim 2, wherein the first member and the second member have magnetic forces of different polarities.

5. The secondary battery as claimed in claim 2, wherein the first member has the magnetic force, and wherein the second member comprises at least one of iron, iron alloy, nickel, or cobalt alloy.

6. The secondary battery as claimed in claim 2, wherein the first member comprises:
a first body fixed to the peripheral portion and having elasticity; and
a first wing extending from the first body in a direction toward the second member and having the magnetic force.

7. The secondary battery as claimed in claim 6, wherein the second member comprises:
a second body fixed to the peripheral portion and having elasticity; and
a second wing extending from the second body in a direction toward the first member and having the magnetic force.

8. The secondary battery as claimed in claim 7, wherein the first member comprises a first protrusion and a first groove, and wherein the second member comprises a second groove detachably coupled to the first protrusion and a second protrusion detachably coupled to the first groove.

9. The secondary battery as claimed in claim 1, wherein the cap plate and the safety vent are integrally molded by a double injection molding process.

10. The secondary battery as claimed in claim 1, further comprising an insulating member having a shape corresponding to the cap plate and located between the cap plate and the electrode assembly.

11. A secondary battery comprising:
an electrode assembly comprising a first electrode plate, a second electrode plate, and a separator;
a case accommodating the electrode assembly, the case comprising a top opening;
a cap plate sealing a top opening of the case, the cap plate comprising a vent hole; and
a safety vent on the cap plate wherein the safety vent is configured to move between a closed position closing the vent hole and an open position opening the vent hole, wherein the safety vent has a magnetic force biasing the safety vent into the closed position, and,
wherein the safety vent comprises a plurality of layers.

12. The secondary battery as claimed in claim 11, wherein the safety vent comprises:
a first vent portion on the cap plate, the first vent portion being configured to move between a closed position closing the vent hole and an open position opening the vent hole and comprising a magnetic force biasing the first vent portion into the closed position; and
a second vent portion at a lower side of the first vent portion and on the cap plate together with the first vent portion, the second vent portion being configured to move between a closed position closing the vent hole and an open position opening the vent hole and comprising a magnetic force biasing the second vent portion into the closed position.

13. The secondary battery as claimed in claim 12, wherein the first vent portion comprises:
a border-shaped peripheral portion fixed to a portion of the cap plate facing the vent hole;
a first member extending from one side of the peripheral portion toward a center of the vent hole; and
a second member extending from an other side of the peripheral portion toward the center of the vent hole.

14. The secondary battery as claimed in claim 13, wherein the first member and the second member each comprise a magnetic material.

15. The secondary battery as claimed in claim 14, wherein the magnetic material comprises a plastic magnet.

16. The secondary battery as claimed in claim 15, wherein the plastic magnet comprises an organic ferromagnetic material (p-TCNQ).

17. The secondary battery as claimed in claim 13, wherein a region where the first member and the second member are detachably coupled to each other has any one of an “I” shape, an “S” shape, or a “W” shape in plan view.
